(19) United States
(12) Patent Application Publication
(10) Pub. No.: US 2003/0206285 A1
(43) Pub. Date: Nov. 6, 2003

(54) Nine dimensional laser tracking system and method

(75) Inventor: Kam C. Lau, Potomac, MD (US)

Correspondence Address: NIXON PEABODY, LLP, 8180 GREENSBORO DRIVE, SUITE 800, MCLEAN, VA, 22102, US

(73) Assignee: AUTOMATED PRECISION, INC., Rockville, MD (US)

(21) Appl. No.: 10/429,680

(22) Filed: May 6, 2003

Related U.S. Application Data
(60) Provisional application No. 60/377,596, filed on May 6, 2002.

(51) Int. Cl. G01B 9/02

(52) U.S. Cl. 356/4.09

(57) ABSTRACT

A laser based tracking unit communicates with a target to obtain position information about the target. Specifically, the target is placed at the point to be measured. The pitch, yaw and roll of the target, and the spherical coordinates of the target relative to the tracking unit are then obtained. Then additional information regarding a probe attached to the target reconciled with the above determination to determine a position of a probe tip. The target can be, for example, an active device incorporated into a moveable device such a remote controlled robot.

### RELATED APPLICATION DATA

This application claims the benefit of and priority under 35 U.S.C. §119(e) to U.S. Patent Application Serial No. 60/377,596, filed May 6, 2002, entitled “9-D Laser Tracking System with Hidden Point Measuring Capability,” and is related to U.S. patent application Ser. No. 10/225,134, filed Aug. 22, 2002, entitled “Six Dimensional Laser Tracking System and Method,” U.S. Pat. No. 4,714,339 entitled “Three And Five Axis Laser Tracking Systems,” and U.S. Pat. No. 6,049,377 entitled “Five-Axis/Six-Axis Laser Measuring System” all of which are incorporated herein by reference in their entirety.

### BACKGROUND OF THE INVENTION

1. Field of the Invention

In general, the systems and methods of this invention relate to laser tracking systems. In particular, the systems and methods of this invention are directed toward a nine dimensional (9-D) laser tracking system.

2. Description of Related Art

Precision measuring systems have a wide variety of applications. For example, in robotics, accurate positioning and orientation of a robot is often required. To achieve a high degree of precision, a robot position measuring system can be used. Such a system typically uses a laser tracker to determine the position and/or the orientation of an end-effector of the robot. This system can monitor the position and orientation of the robot end-effector in real-time while providing accuracy, speed and measurement data.

### SUMMARY OF THE INVENTION

The exemplary systems and methods of this invention employ a combination of a tracking unit and an active target to accomplish nine-dimensional laser tracking. In particular, the nine dimensions are pitch, yaw, and roll of the active target, and the spherical coordinates, i.e., the two angles α and θ, the radial distance of the target relative to the tracking unit and the pitch, yaw and length (d) of a probe relative to the active target. By using an active target, the active target coordinates maintain a relatively perpendicular relation to the incoming beam. Additionally, by employing an absolute distance measurement technique, absolute ranging is possible.

In general, the pitch and yaw based measurements can be derived from an encoder present on the active target. The roll measurements can be based on, for example, a polarization or an electronic level technique (discussed hereinafter). The absolute distance measurements (ADM) can be accomplished using, for example, repetitive time of flight pulses, a pulsed laser, phase/intensity modulation, or the like.

Specifically, a repetitive time of flight (RTOF) based system comprises a photodetector, such as a PIN photodetector, a laser amplifier, a laser diode and a frequency counter. A first laser pulse is fired to the target. Upon detecting the return pulse, the detector triggers the laser amplifier and causes the laser diode to fire a second pulse, with the pulses being detected by the frequency counter. However, it is to be appreciated that the reverse logic will also work with equal success. The distance (D) of the target from the tracking unit would then be given by:

$$D = \frac{C}{4} ( \frac{1}{f} - \frac{1}{{f}_{0}} )$$

such that:

D=0;f=f₀

where C is the speed of light, f₀ is a reference frequency and f is the frequency of the pulses.

The systems and methods of this invention have various applications. In general, the systems and methods of this invention allow the monitoring of up to nine degrees of freedom of an object. For example, the systems and methods of this invention can be used for structural assembly, real-time alignment and feedback control, machine tool calibration, robotic position control, position tracking, milling machine control, calibration, parts assembly, or the like.

Additionally, the systems and methods of this invention, using the 9-D tracking system, lend themselves to use in the robotic arts. For example, the 9-D laser tracking system can be incorporated into a robot, that is, for example, capable of scaling various objects such that, for example, precise measurements can be taken of those objects and/or various functions performed at specific locations on the object.

In accordance with an exemplary embodiment of the invention, aspects of the invention relate to a 9-D laser tracking system.

An additional exemplary aspect of the invention relates to determining roll based on measurements from a polarized laser head.

Additionally, exemplary aspects of the invention relate to the design and use of an active target in conjunction with a tracking unit.

Additionally, exemplary aspects of the invention relate to the use of the active target on a robotic device.

Additional exemplary aspects of the invention also relate to a remotely controlled robot that incorporates active target technology.

Exemplary aspects of the invention also relate to incorporating a probe on the active target to, for example, allow the measurement of hidden points.

Exemplary aspects of the invention further relate to determining the distance of a probe tip from an origin.

Exemplary aspects further relate to a rotatable, extendable probe attached to the active target.

Aspects of the invention further relate to a method of measuring a hidden point.

Aspects of the invention further relate to an exemplary method of determining the location of a probe associated with an active target.

These and other features and advantages of this invention are described in or are apparent from the following detailed description of the embodiments.

### BRIEF DESCRIPTION OF THE DRAWINGS

The embodiments of the invention will be described in detail, with reference to the following figures wherein:

FIG. 1 illustrates an exemplary 6-D tracking system according to this invention;

FIG. 2 is a block diagram illustrating an exemplary roll determination system according to this invention;

FIG. 3 is a block diagram illustrating an exemplary pitch, yaw, roll and distance measuring system according to this invention;

FIG. 4 is an exemplary remote controlled robot incorporating the active target system according to this invention;

FIG. 5 is a cross-sectional view of the exemplary remote controlled robot according to this invention;

FIG. 6 illustrates an exemplary 9-D tracking system according to this invention;

FIG. 7 illustrates a detailed view of a second exemplary active target according to this invention;

FIG. 8 illustrates a detailed view of an exemplary probe assembly according to this invention;

FIG. 9 illustrates a detailed view of a second exemplary probe assembly according to this invention;

FIG. 10 illustrates a detailed view of a third exemplary probe assembly according to this invention;

FIG. 11 is a flowchart illustrating an exemplary method of taking measurements according to this invention;

FIG. 12 is a flowchart illustrating an exemplary method of initializing a multidimensional laser tracking system according to this invention;

FIG. 13 is a flowchart illustrating an exemplary method of taking measurements according to this invention; and

FIG. 14 is a flowchart illustrating a second exemplary method of taking measurements according to this invention.

### DETAILED DESCRIPTION

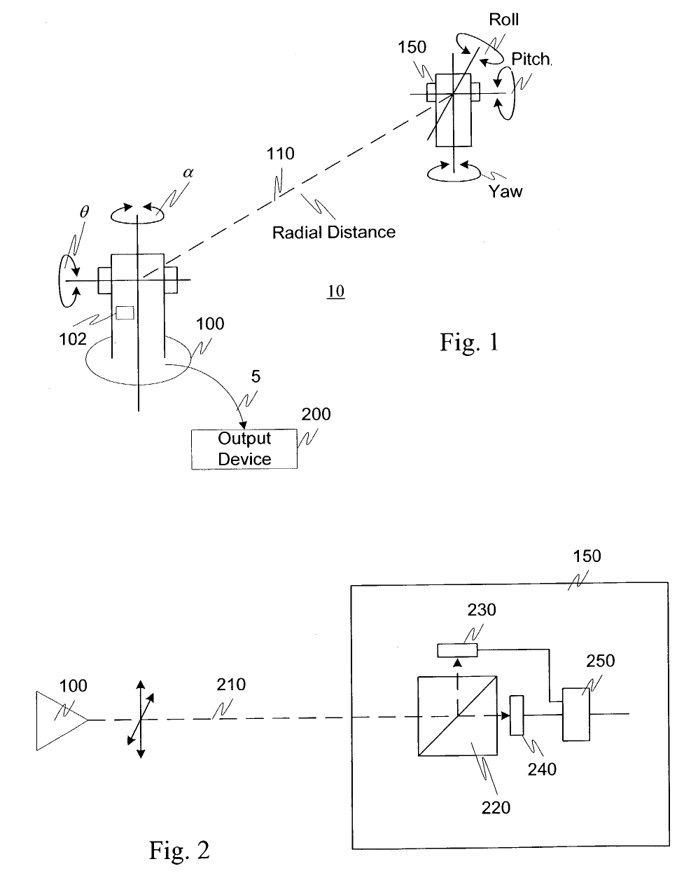

FIG. 1 illustrates an exemplary 6-D laser tracking system. In particular, the laser tracking system comprises a tracking unit 100 and an active target 150. The tracking unit 100 emits one or more lasers 110 that communicate with the active target 150 to determine the six dimensional measurements which are output on output device 200. In particular, the six dimensions illustrated are pitch, yaw and roll of the active target and the spherical, and once converted Cartesian, coordinates of the tracking unit 100.

The exemplary systems and methods of this invention will be described in relation to a tracking and/or measuring system. However, to avoid unnecessarily obscuring the present invention, the following description omits well-known structures and devices that may be shown in a summarized form. For the purposes of explanation, numerous specific details are set forth in order to provide a thorough understanding of the present invention. It should be however appreciated that the present invention may be practiced in a variety of ways beyond the specific details set forth herein. Additionally, the term module as used herein can refer to any known or later developed hardware, software, or combination of hardware and software that is capable of performing the functionality associated with that element.

As discussed in Applicant's previous patents, the pitch, yaw and spherical coordinate measurements can be based on various technologies. For example, the pitch and yaw measurements can be based on, for example, a rotary encoder.

Additionally, the distance measurements can be based on, for example, a pulsed laser configuration, a repetitive time of flight pulse, phase and/or intensity modulation of the laser beam, or the like. These various systems can provide absolute ranging of the active target. Thus, the active target need not be returned to a known position, such as with a passive target, before distance measurements can commence. Specifically, an absolute distance measurement technique can be used to determine an approximate initial distance and then an interferometer based technique used to refine the initial distance measurement.

The tracking unit 100 and the active target 150 can be, for example, motorized units that allow one or more portions of the tracking unit 100 and the active target 150 to maintain a perpendicular orientation to the incoming laser beam 110 emitted from the tracking unit 100. Thus, through a combination of rotary encoders and motors that employ position signals from one or more photodetectors, as discussed hereinafter, the active target is capable of remaining perpendicular to the incoming laser beam 110. For example, through the use of a gimbal type mount and corresponding position motors, such as stepping motors, servo motors and/or encoders, the active target “tracks” the tracking unit 100. Based upon the relationship of the active target to the incoming laser, the 6-D laser tracking system 10 is able to determine the orientation of the active target. Alternatively, the target can be a passive device, for example, a hand-held device such as a corner cube, for which a user would be responsible for maintaining a line of site between the target and the tracking unit 100.

The tracking unit 100 is also capable of being miniaturized by incorporating both the absolute distance measurement and interferometer electronics in, for example, the gimbaled portion of the tracking unit 100. This provides various exemplary advantages including reduced weight, reduced size, minimization of external connections, quicker tracking speeds, and the like. For example, the tracking unit 100 can comprise a distance determination module that is adapted to determine distance between the tracking unit and the target.

The output device 200, connected to one or more of the tracking unit 100 and target 150 via a wired or wireless link 5, outputs position information about the target 150. For example, the output device 200 can be a computer, a feedback input for a position control device, a display, a guidance system, or the like. In general, the output device can be any device capable of outputting target position information. Likewise, it should be appreciated that audio and/or video communication could be established between the output device and the target 150.

Additionally, the one or more lasers 110 can be used to communicate position information about the target 150 back to the tracking unit 100. For example, after an initial distance is determined, the laser used for the absolute distance measurement can be used for data communication and the interferometer based laser used for the radial distance measurements. Alternatively, a dedicated laser can be incorporated into the system that would allow, for example, full time communication between the target and the tracking unit.

FIG. 2 illustrates an exemplary system for determining roll. In particular, the system comprises a laser source, such as a laser head (not shown), located in the tracking unit 100, a polarized laser beam 210, a polarizing beam splitter 220, a first photodetector 230, a second photodetector 240 and a roll determination circuit 250, such as a differential amplifier.

In operation, the laser source 100 emits a polarized laser beam 210 that is received by the polarizing beam splitter 220. The polarizing beam splitter splits the incoming beam into two paths. A first path is directed toward the first photodetector 230 and a second path of the polarized laser beam 210 is directed toward the second photodetector 240. When the polarized laser beam encounters the polarizing beam splitter 220, the polarized laser beam 210 is split into horizontally polarized and vertically polarized components as a result of the properties of the beam splitter 220. The horizontally polarized portion of the beam passes through the polarized beam splitter 220 to the photodetector 240. The photodetector 240 generates an output signal corresponding to the intensity of the horizontally polarized portion of the beam. The vertically polarized portion of the beam is directed by the beam splitter 220 onto the photodetector 230. The photodetector 230 also produces a signal corresponding to the intensity of the vertically polarized portion of the beam. The intensity measurements of the photodetectors 230 and 240 can be connected to, for example, the positive and negative inputs, respectively, of a high-gain differential amplifier 250, which provides an output signal representative of the roll between the laser source 100 and the active target 150.

The polarized laser beam 210 is split into two different polarized portions based on the exact roll orientation between the tracking unit 100 and the active target 150. At a 45° roll orientation, the photodetectors 230 and 240 will receive the same intensity. However, as the active target 150 is rolled in either direction from 45°, one of the detectors will receive a greater intensity of the polarized laser beam than the other. The difference between these outputs is measured by, for example, the differential amplifier 250, to provide an indication of the roll of the active target 150. This subtraction operation of the differential amplifier 250 also advantageously compensates for background and extraneous noise, such as that produced by fluctuations in the beam intensity and/or background light.

For example, variations in the beam output, as well as other signal noise that may be present, can be measured by both the photodetector 230 and photodetector 240. These variations can be negated by the differential amplifier's operation. This, for example, increases the sensitivity and accuracy of the system.

The signal representative of the roll can be output to, for example, a computer or comparable output device provided with software that is capable of recording, analyzing or initiating a further action based on the roll measurement.

Alternatively, other techniques may be used for roll determination. These techniques include, but are not limited to, electronic levels, such as pendulum based techniques, conductive fluid capillary tube techniques, liquid mercury reflective sensors, or, in general, any technique, system or method that allows the roll of the target to be determined.

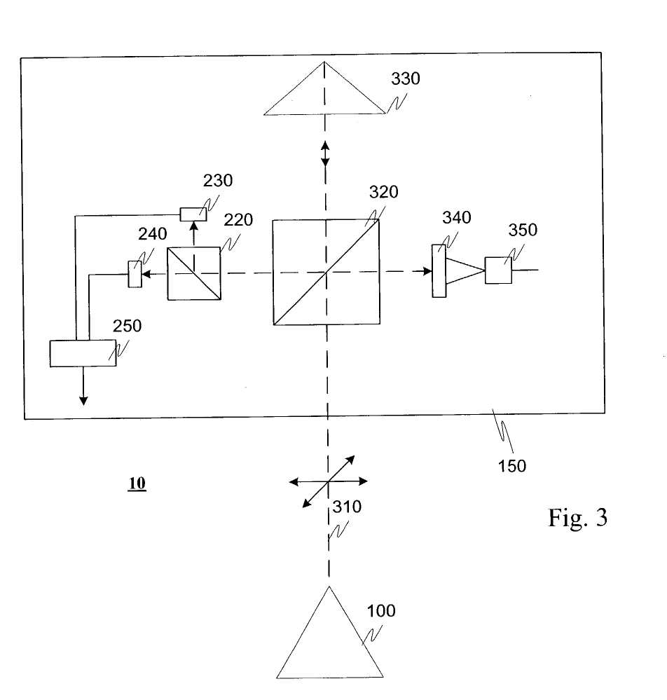

FIG. 3 illustrates the exemplary orientation determining components used for the 6-D laser tracking system. In particular, the components of the 6-D laser tracking system 10 comprise a laser source present in the tracking unit 100, a polarized laser beam 310, a beam splitter 320, a corner cube 330, a concentrator lens 340, a two-dimensional photodetector 350, the first photodetector 230, the second photodetector 240, the polarizing beam splitter 220 and the roll signal determination device 250.

In operation, the laser source in the tracking unit 100 emits a polarized laser beam 310 that is split by the beam splitter 320 into three paths directed toward the concentrator lens 340, the corner cube 330 and the polarizing beam splitter 220, respectively.

The path directed toward the concentrator lens 340 is focused onto the two-dimensional photodetector 350 from which the pitch and yaw signals that drive the motors for the active target are derived. In particular, as the active target 150 moves relative to the laser source 100, the laser path directed through the concentrator lens 340 moves relative to the 2-D photodetector 350. This movement can be detected and a corresponding signal representative of the pitch and/or yaw measurement obtained. Then, as discussed above, the pitch and/or yaw measurements can be used to control one or more motors on the active target 150 to maintain the perpendicular orientation of the active target 150 to the tracking unit 100.

The path of the polarized laser beam 310 passing directly through the beam splitter 320 is reflected by the corner cube 330 and returned to the tracking unit 100. The tracking unit 100, as discussed in Applicant's related patents, is then able to determine the distance between the active target 150 and the tracking unit 100. However, it is to be appreciated that any method of determining a distance, such as an absolute distance measurement, can be used with equal success with the systems and methods of this invention.

The path of the beam reflected by the beam splitter 320 and directed toward the polarized beam splitter 220 is used to determine the roll measurements, as discussed above. The combination of the roll, the pitch and the yaw measurements made by the active target, along with the spherical coordinates made the tracking unit 100, allows the tracking system to obtain the six-dimensional tracking of the active target.

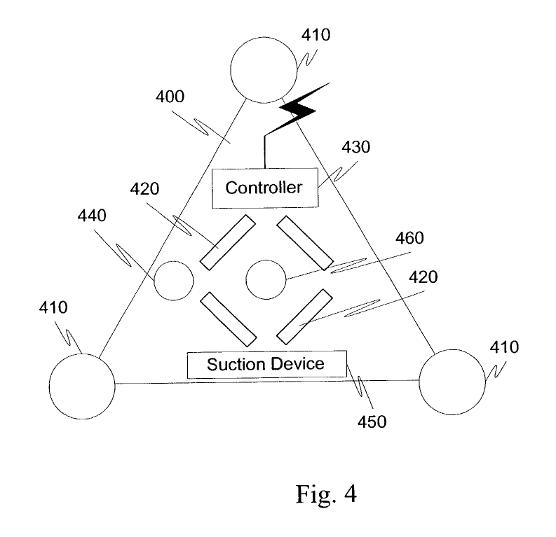

FIG. 4 illustrates an exemplary robotic active target 400. The robotic active target 400 comprises a plurality of suction cup type devices 410, a drive mechanism 420, a controller 430, an accessory 440, a suction device 450 and the active target 460. The robotic active target 400 also comprises various other components such as a power supply, battery(ies), solar panels, or the like that have been omitted for sake of clarity and would be readily apparent to those of ordinary skill in the art.

In operation, the combination of the active target 460 in conjunction with the robotic active target 400 allows, for example, precise movement and location tracking of the robot. While a particular robotic active target is discussed below, it is to be appreciated that in general the active target can be fixably attached to any object to allow monitoring of up to six degrees of freedom of the object, or, alternatively, the active target attached to any device and the position of that device monitored.

The suction cup type devices 410 are connected to the suction device 450 via, for example, hoses (not shown) that enable the robot 400 to remain affixed to a surface. For example, the controller 430, in conjunction with the suction device 450 and the suction cup type devices 410 can cooperate with the drive systems 420 such that the robot 400 is able to traverse a surface. For example, the suction cup type devices 410 and the drive mechanism 420 can cooperate such that sufficient suction is applied to the suction cup type devices 410 to keep the robot 400 affixed to a surface, while still allowing the drive mechanism 420 to move the robot 400 over the surface. For example, the drive mechanism 420 can be four wheels, and associated drive and suspension components (not shown), as illustrated. The wheels allow the traversal of the robot 400 over a surface while maintaining the rotational orientation of the robot relative to the tracking unit 100. However, in general, while it is simpler to operate the robot 400 such that the rotational orientation remains constant relative to the tracking unit 100, the system can be modified in conjunction with the use of the polarized laser to account for any rotational movement which may occur. Specifically, for example, the rotational movement of the robot 400 can be algorithmically “backed-out” of the orientation measurements based on the polarized laser to account for any rotation of the robot 400.

Furthermore, it should be appreciated that while exemplary robot 400 comprises a suction device 450 and suction cup type devices 410, any device, or combination of devices, that are capable of movably fixing the robot to a surface would work equally well with the systems and methods of the invention. For example, depending on the surface type, a magnetic, gravitational, resistive, or the like type of attachment system could be employed. Likewise, the construction of the robot 400 can be varied based on, for example, environmental conditions, or be adapted to be retrofit on, for example, a vehicle.

The controller 430, which can, for example, be in wired or wireless communication with a remote controller (not shown), allows for navigation of the robot 400 in cooperation with the drive mechanism 420. For example, the drive mechanism can be a plurality of electric motors connected to the drive wheels 420, or the like.

The accessory 440, can be, for example, a marking device, a tool, such as a drill, a painting attachment, a welding or cutting device, or any other known or later developed device that needs precise placement on a surface. The accessory can be activated and optionally monitored via a video recorder, for example remotely, in cooperation with the controller 430.

Since the accessory 440 is located a known distance from the active target 460, the exact position of the accessory 440 is always known. Thus, a user can position the accessory 440 in an exact location such that the accessory 440 can perform an action at that location. Furthermore, as discussed hereinafter, the exact location of a tool at the end of the accessory can be determined. For example, using the techniques discussed later, the exact location of the tip of a drill bit can be known as it drills into a substance. Alternatively, or in conjunction with the above, for example, a local effect sensor like a strip camera, a Moiré fringe patent sensor, or a touch probe can be attached to the end of the target. The tracking unit combined with the active target can provide the orientation of the local sensor in a spatial relationship with the part to be measured while the local sensor is measuring the contours of a part, such as a car body, a building, a part in an environmentally hazardous area, or the like.

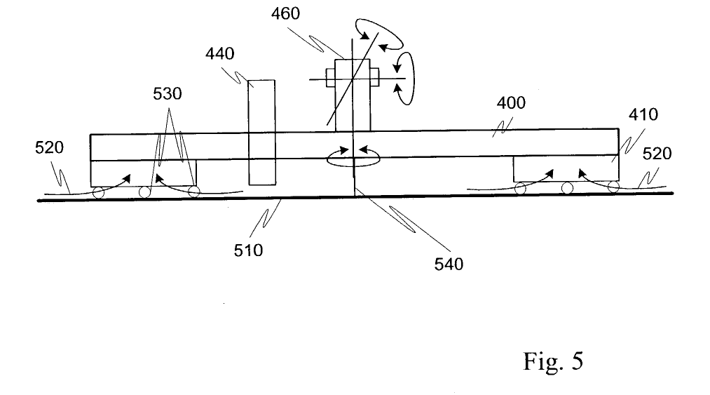

FIG. 5 illustrates an cross-sectional view of the exemplary robot 400. In addition to position sensing equipment associated with the active target 460, a movable distance determining device 540 extends from the base of the robot 400 to a surface 510. The distance determining device 540 measures the exact distance between the active target 460 and the surface 510 such that the exact location of the surface 510 relative to the active target 460 is always known.

As illustrated in FIG. 5, the suction cup type devices 410 are located a fixed distance above the surface 510 via the spacers 530. For example, the spacers 530 can be a bearing, or other comparable device that allows for the suction cup type devices 410 to remain a fixed distance above the surface 510 while still allowing the air 520 to create a suction between the robot 400 and the surface 510.

Given the mobility of the robot 400, it is foreseeable that the robot may not always be in communication with the tracking unit 100. In the event the robot 400 loses line-of-sight with the tracking unit 100, the 6-D laser tracking system can then enter a target acquisition mode. In this mode, a user can, for example, with a joystick, aim the tracking unit generally in the vicinity in the robot 400. The tracking unit 100 then commences a target acquisition process in which the tracking unit begins, for example, a spiral type pattern that spirals outward to locate the active target. Upon acquisition of the target, communication between the tracking unit and the active target 150 is established and the measurements are again available.

Alternatively, for example, the active target 150 can maintain communication with the tracking unit 100 via, for example, a radio communication link, or other known or later developed system, such as GPS, that allows the tracking unit 100 to track the relative position of the active target 150 regardless of whether line-of-sight is present. Thus, when line-of-sight is reestablished, as discussed above, the measurements are available.

However, there may be instances, for example, where the point to be measured, or surface to be mapped, is not in the line-of site of the tracking unit, or, alternatively, for example, the point to be measured is inaccessible by the active target.

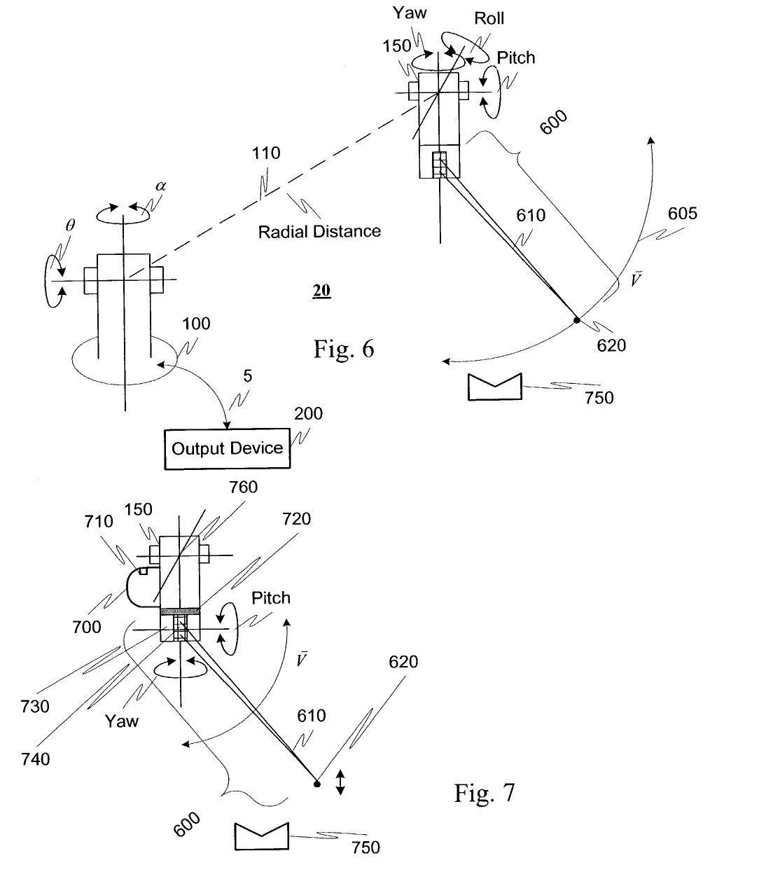

Accordingly, FIG. 6 illustrates an exemplary embodiment 20 where a probe assembly 600 is affixed to the active target 150. In particular, the probe assembly 600 comprises a probe 610 a probe tip 620 and an attaching mechanism (not shown).

In the exemplary embodiment illustrated in FIG. 6, the probe 610 is adapted to traverse arc 605. To initialize the system, the probe tip 620 is placed into a seat 750 that is at a known position relative to the tracking unit 100. The active target 150 is then moved such that the probe tip 620 is swept through arc 605 ( [symbol] ). As the probe tip is swept through arc 605 a point cloud is established that represents the distance of the probe tip 620 from an origin, such as origin 760 illustrated in FIG. 7, relative to [symbol] .

For example, the probe assembly 600 can comprise an encoder, such as a rotary encoder that can measure [symbol] . This point cloud can be stored in, for example, one or more of the active target 150 and the tracking unit 100 such that if [symbol] is known, the position of the probe tip 620 is known.

For example, in operation, and after initialization where the probe 610 is locked in place, for example with the use of a wing nut and associated locking teeth, the probe tip is placed on the object to be measured. Since, in accordance with the previously discussed embodiments, the position of the active target 150 is known, the position of the probe tip can be determined based on the position of the active target 150 in combination with [symbol] and the point cloud determined during initialization. This thus provides seven dimensions of measurement (7-D).

FIG. 7 illustrates an alternative exemplary embodiment where the probe assembly 600 is cabable of movement along 2 axies. In particular, and in accordance with this exemplary embodiment, the active target 150 further comprises a handle assembly 700, a trigger 710, an encoder, such as a rotary encoder 720, a probe base 730, and an encoder 740.

In this exemplary embodiment, the operation is similar to that discussed in relation to the embodimet illustrated in FIG. 6, with the additional variable that the probe base 730 can be rotated in the yaw direction relative to the active target 150. Thus, during initialization, when the probe tip 620 is placed into the seat 750, both V and the rotation of the probe base 730 relative to the active target 150, which is derived from measurements taken by the rotary encoder 720, are stored to develop a point cloud, which is approximately a sphere, that is used to determine the position of the probe tip 620. Therefore, during use, a user places the probe tip 620 on the point to be measured, squeezes trigger 710, and using both [symbol] and the rotation of the probe base 730 relative to the active target 150, the position of the pobe tip 620 can be determined. This thus provides the eight dimensions of measurement (8-D).

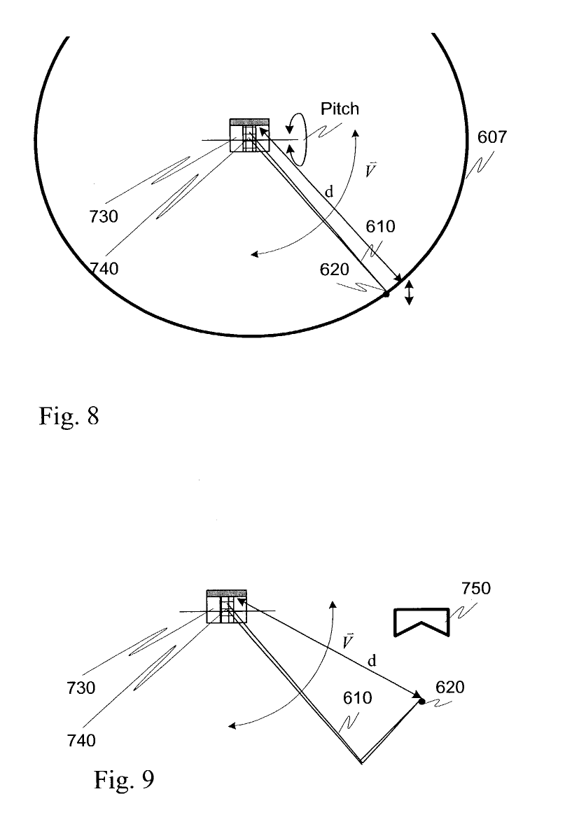

FIG. 8 illustrates an exemplary point cloud 607, that if projected in three dimensions relative to the probe base 730, represents the distance d of the probe tip 620 fom an origin, such as the origin of the the active taget 760 shown in FIG. 7. During initialization, this point cloud, as discussed above, can be stored at one or more of the active target 150, the tracking unit 100 or, for example, in an associated computer and/or output device that cooperates with the active target 150 and the tracking unit 100 to monitor measurements made by the active target 150. This point cloud can be stored as a look-up table, or the like, that when combined with the position information of the active target 150 provides location information about the probe tip 620.

Thus, for example, multiple fixed-length probes 610, once initialized, can be interchanged on the active target 150, and the apropriate data corresponding to that probe, such as a look-up table, selected for the installed probe. For example, probes of different sizes and shapes, with different size and shape probe tips 620 can be installed on the active target 150. Specifically, a user interface (not shown) on the associated computer could be adapted to prompt a user to select the probe 610 currently installed on the active target 150. The active target 150 could then be graphically ilustrated on the associated computer having the attached probe 610.

FIG. 9 illustrates an alternative exemplary embodiment of the probe 610 where the probe is in an “L” shape. However, in general, the probe can be in any shape and the user only need adjust the seat 750 such as to allow the probe tip 620 to sit in the seat 750 during an initialization to create the point cloud.

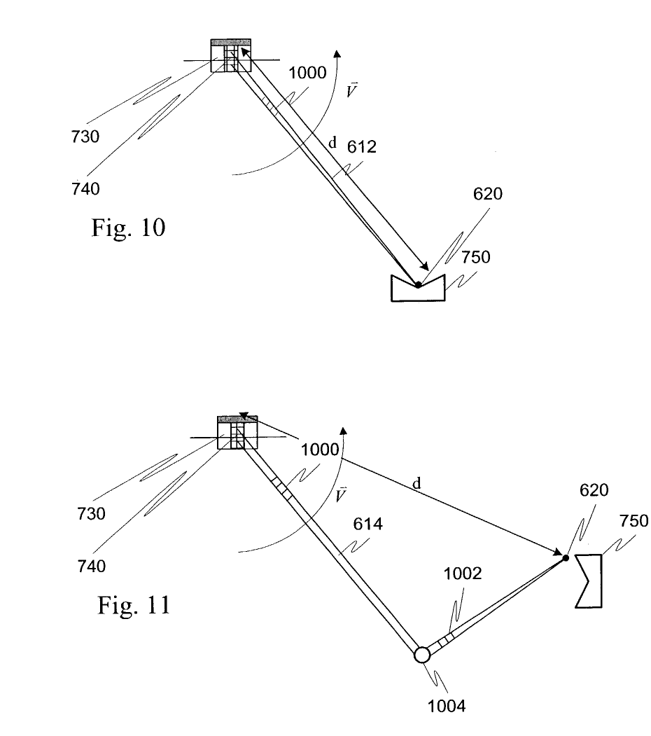

FIG. 10 illustartes a 9-D version of an exemplary active target according to this invention. In particular, in addition to the single axis movement of the probe 610 illustrated in FIG. 6, and the 2^{nd} axis of movement of the probe 610 illustrated in FIG. 7, the probe 612 in FIG. 10 is capable of exdending in a longitudinal direction, i.e., telescoping. With the aid of the encoder 1000, which can be, for example a glass-scale encoder, a linear scale encoder, a magnescale encoder, or the like, the length of the probe 610 can be determined.

Thus, in operation, a user can either adjust and fix the length of the probe 612 and perform initialization, with the length of the probe remaining static in a seat 7500 during measurements, or, in addition to the steps ennumertaed above, also vary the length of the probe 612 during initialization to create a semi-solid point cloud (not shown) that represents the distance d of the probe tip 620 from an origin relative to the rotational movement of the probe base 730, the length of extension of the probe 612 and [symbol] . As discussed previously, the various readings from the encoders are then stored to be used for actual position determination during the measurement process.

During use, one or more of the probe length, probe rotation and [symbol] can be varied by the user as approprioate to allow the probe tip to be placed on the object to be measured/traversed. Furthermore, while the probe tip is illustrated herein is a sphere, it is to be appreciated that the tip can be any shape, such as a point, cup, bearing that allows the probe to move across an object, or the like. For example, as discussed previously, a measurement can be taken instantaneously using the trigger 710, or continuously, for example, while the probe tip traverses an object.

FIG. 11 illustartes another exemplary active target according to this invention. In particular, in addition to the single axis movement of the probe 61 illustrated in FIG. 6, and the 2^{nd} axis of movement of the probe 610 illustrated in FIG. 7, the probe 612 exdending in a longitudinal direction, i.e., telescoping, the probe 614 extends in a second longitudinal direction, with the aid of the elbow 1004 and encoder 1002. Specifically, based on the combination of encoder 1000 and encoder 1002, which can be, for example, a glass-scale encoders, linear scale encoders, magnescale encoders, or the like, or any combination thereof, and the position of encoder 1004, the length of the probe 610 can be determined.

Thus, as above, a user can either adjust and fix the length of the probe 614 and perform initialization, with the length of the probe remaining static in a seat 750 during initialization, or, in addition to the steps ennumertaed above, also vary the length of the probe 614 during initialization to create a semi-solid point cloud (not shown) that represents the distance d of the probe tip 620 from an origin relative to the rotational movement of the probe base 730, the length of extension of the probe 614, the angle of the encoder 1004 and [symbol] . As discussed previously, the various readings from the encoders are then stored to be used for actual position determination during the measurement process.

During use, one or more of the probe length, probe rotation, encoder 1004 angle and [symbol] can be varied by the user as approprioate to allow the probe tip to be placed on the object to be measured/traversed. Thus, it should be appreciated the the basic concepts disclosed herein can be expanded to encompass any configuration of fixed or variable sixe/length probe, provided th probe's various lengths and positions are established through an initialization session.

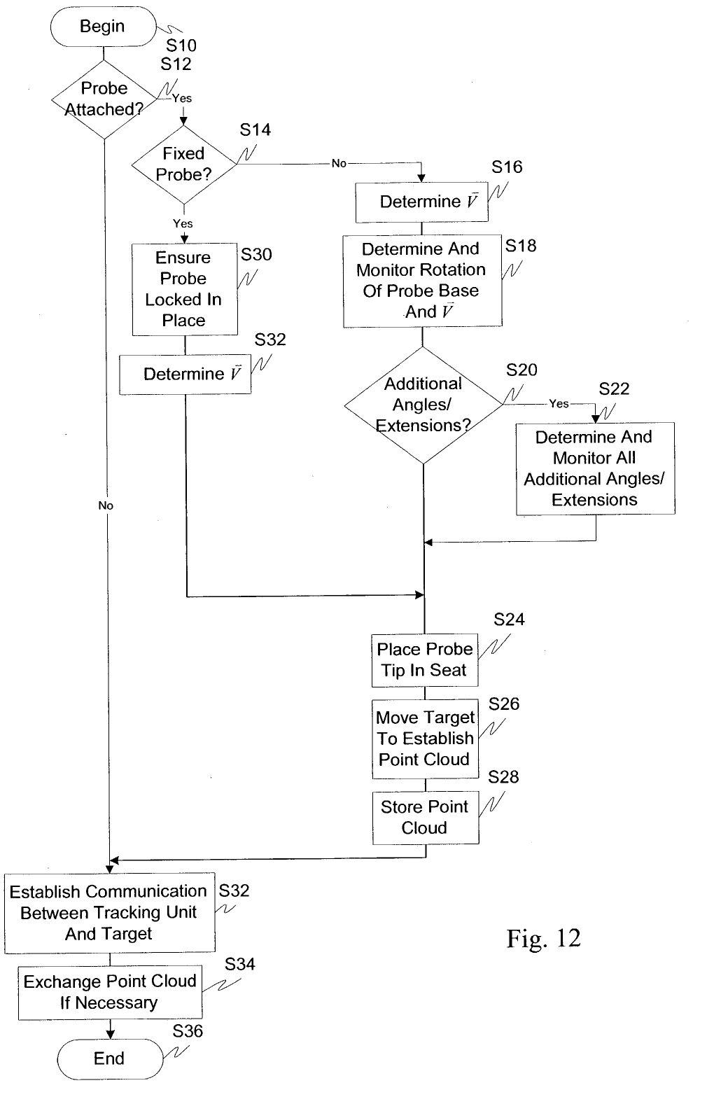

FIG. 12 illustrates an exemplary method of initializing the measurement system. In particular, control begins in step S10 and continues to step S12. In step S12, a determination is made whether a probe is attached to the target. If a probe is attached to the target, control continues to step S14. Otherwise, control jumps to step S40.

In step S14, a determination is made whether the probe is fixed. If the probe variable, control continues to step S16. Otherwise, control jumps to step S30. In step S16 [symbol] is determined. Next, in step S118, the position of the probe base is determined and monitored. Then, in step SS20, a determination is made whether additional angles and/or extension are present in the probe. If additional angles/extensions are present, control continues to step S22 where the positions of all additional angles and extensions are monitored. Control then continues to step S24.

In step S30, the probe is fixed in the locked position. Next, in step S32, [symbol] is determined. Control then jumps to step S24.

In step S24, the probe tip is placed in the seat. Next, in step S26, the target is moved to establish a point cloud. Then, in step S28, the point cloud is stored. Control then continues to step S32. For example, an operator creates a spherical point cloud by placing the probe tip in a seat 750 and sweeps the probe base 730 through a sphere in space. The resulting point cloud's center coordinate is used to determine the probe vector. A second method for determining the probe vector entails measuring seat 750 with a known coordinate position and the coordiante position of the active target 150 which is determined from the tracker 100.

In step S32, the communications between the tracking unit and the target are established. Next, in step S34, the point cloud is transferred as required. Control then continues to step S36 where the control sequence ends.

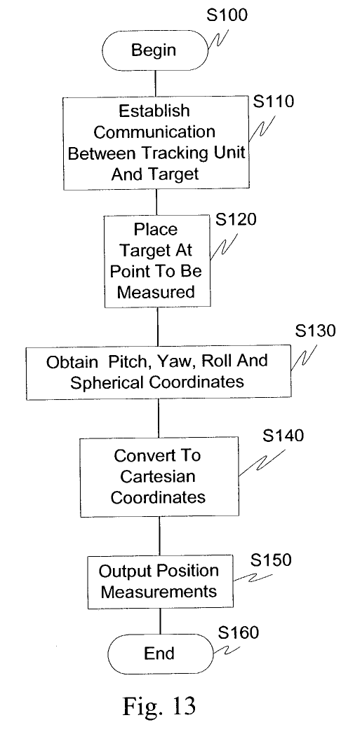

FIG. 13 illustrates an exemplary method of making measurements according to an exemplary embodiment of this invention. In particular, control begins in step S100 and continues to step S110 where communication between the tracking unit and target are established. For example, for an interferometer based system, the target can be placed at a known position to both establish communication with the tracking unit as well as to initialize the system. For an absolute distance measurement system the target is placed in communication with the laser and an approximate radial distance (R) obtained. Next, in step S120, the target is placed at the point(s) to be measured. Then, in step S130, the pitch, yaw, roll and spherical coordinates obtained. Control the continues to step S140.

In step S140, the spherical coordinates are converted to Cartesian (x,y,z) coordinates, where x is the horizontal position, y the in/out position and z the up/down position of the target. Then, in step S150, the position measurements are output. Control then continues to step S160 where the control sequence ends.

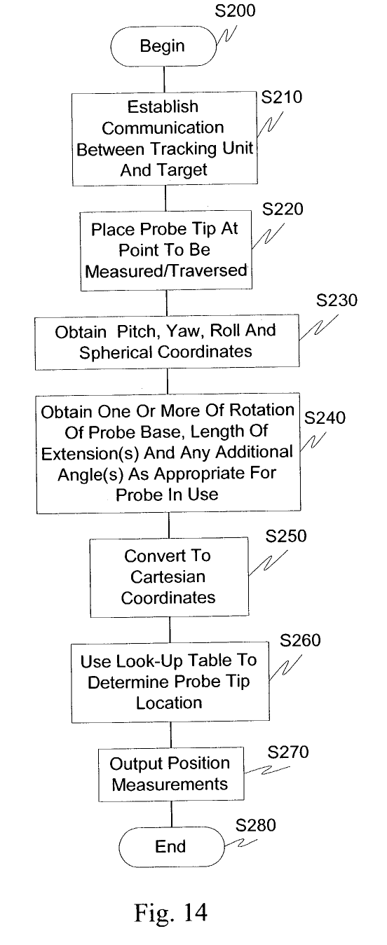

FIG. 14 illustrates an exemplary method of making measurements according to a second exemplary embodiment of this invention. In particular, control begins in step S200 and continues to step S210 where communication between the tracking unit and target are established. For example, as above, for an interferometer based system, the target can be placed at a known position to both establish communication with the tracking unit as well as to initialize the system. For an absolute distance measurement system the target is placed in communication with the laser and an approximate radial distance (R) obtained. Next, in step S220, the probe tip is placed at the point(s) to be measured. Then, in step S230, the pitch, yaw, roll and spherical coordinates obtained. Control the continues to step S240.

In step S240, one ore more of the rotation of the probe base, the length of any extension(s), and any additional information from supplemental encoders in use obtained. Next, in step S250, the spherical coordinates are converted to Cartesian (x,y,z) coordinates, where x is the horizontal position, y the in/out position and z the up/down position of the target. Then, in step S260, the measurements from the probe are compared to information stored in the look-up table to determine the location of the probe tip. For example, a profile can be associated with each probe and/or probe tip, such that when a probe is affixed to the target, the profile specifies which look-up table is to be used. Control then continues to step S270.

In step S270, the position measurements are output. Control then continues to step S280 where the control sequence ends.

As illustrated in attached figures, the multidimensional laser tracking system can be implemented either on a single programmed general purpose computer, or a separate programmed general purpose computer and associated laser generating, detecting, motor and rotary encoder components. However, various portions of the multidimensional laser tracking system can also be implemented on a special purpose computer, a programmed microprocessor or microcontroller and peripheral integrated circuit element, an ASIC or other integrated circuit, a digital signal processor, a hard-wired electronic or logic circuit such as a discrete element circuit, a programmable logic device such as a PLD, PLA, FPGA, PAL, or the like. In general, any device capable of implementing a state machine that is in turn capable of implementing the measurement techniques discussed herein can be used to implement the multidimensional laser tracking system according to this invention.

Furthermore, the disclosed methods may be readily implemented in software using object or object-oriented software development environments that provide portable source code that can be used on a variety of computer or workstation hardware platforms. Alternatively, the disclosed multidimensional laser tracking system may be implemented partially or fully in hardware using standard logic circuits or VLSI design. Whether software or hardware is used to implement the systems in accordance with this invention is dependent on the speed and/or efficiency requirements of the system, the particular function, and the particular software and/or hardware systems or microprocessor or microcomputer systems being utilized. The multidimensional laser tracking system and methods illustrated herein, however, can be readily implemented in hardware and/or software using any known or later-developed systems or structures, devices and/or software by those of ordinary skill in the applicable art from the functional description provided herein and a general basic knowledge of the computer and optical arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer such as a Java® or CGI script, as a resource residing on a server or graphics workstation, as a routine embedded in a dedicated multidimensional laser tracking system, or the like. The multidimensional laser tracking system can also be implemented by physically incorporating the system and method into a software and/or hardware system, such as the hardware and software systems of a multidimensional laser tracking system.

It is, therefore, apparent that there has been provided, in accordance with the present invention, systems and methods for multidimensional laser tracking. While this invention has been described in conjunction with a number of exemplary embodiments, it is evident that many alternatives, modifications and variations would be or are apparent to those of ordinary skill in the applicable arts. Accordingly, the invention is intended to embrace all such alternatives, modifications, equivalents and variations that are within the spirit and scope of this invention.

I claim:

1. A multidimensional measurement system comprising:
a tracking unit that emits a laser, the tracking unit having a position represented by spherical coordinates;
a target in communication with the tracking unit, the target having a pitch, a yaw and a roll;
a distance determining module that determines a distance between the tracking unit and the target;
a probe removably affixed to the target, the probe comprising a probe tip that is a distance d from a known location on the target; and
an output device that outputs position information about the probe tip relative to the tracking unit based at least on the pitch, yaw, roll, spherical coordinates distance and distance d.

2. The system of claim 1, wherein the probe is adapted to be moved relative to the target.

3. The system of claim 1, wherein the target and the probe are initialized by a point cloud or fixture with a known position comprising a plurality of the distances d.

4. The system of claim 3, wherein the point cloud is a semispherical map of the position of the probe tip relative to the target.

5. The system of claim 1, wherein the probe is extendable in at least one direction.

6. The system of claim 5, wherein the position information about the probe tip relative to the tracking unit is based at least on the pitch, yaw, roll, spherical coordinates, distance, distance d and point cloud information.

7. The system of claim 1, wherein the probe is rotatable in at least one direction, the rotation represented by encoder information.

8. The system of claim 8, wherein the position information about the probe tip relative to the tracking unit is based at least on the pitch, yaw, roll, spherical coordinates, distance, distance d, vector information and encoder information.

9. The system of claim 1, further comprising a seat, the seat adapted to cradle the probe tip during initialization.

10. The system of claim 7, wherein the seat is at a known coordinate position relative to the tracking unit.

11. The system of claim 1, further comprising a plurality of probes, each probe having a corresponding point cloud used to determine the distance d.

12. The system of claim 1, wherein the roll is based on at least one of a comparison between a horizontally polarized and a vertically polarized portion of the laser, and measurements from an electronic level.

13. The system of claim 1, further comprising a first photodetector that detects a horizontally polarized portion of the laser and a second photodetector that detects a vertically polarized portion of the laser.

14. The system of claim 13, further comprising a differential amplifier that receives an output of the first photodetector and an output of the second photodetector.

15. The system of claim 1, wherein the target is an active target that is capable of moving relative to the tracking unit.

16. The system of claim 15, wherein the active target is at least one of incorporated into a robotic device, fixably attached to an object, fixably attached to a vehicle, used for feedback control, used for calibration, used for machine tool control, used for parts assembly, and used for structural assembly.

17. The system of claim 16, wherein the robotic device comprises a drive system and one or more traction devices that allow the robotic device to adhere to a surface.

18. The system of claim 17, wherein the robotic device is adapted to be remotely controlled.

19. The system of claim 1, further comprising one or more accessories that perform a function at least based on the position of the probe tip.

20. The system of claim 1, wherein the probe is at least one of L-shaped, J-shaped, V-shaped and curved.

21. A method of initializing a multidimensional measurement system comprising:
determining a probe type;
monitoring one or more of rotation of probe base and position of probe relative to a target defined by arc [symbol] ;
placing a probe tip in a known location;
moving the target relative to the known location; and
developing a point cloud representing a distance between the probe tip and a known location on the target.

22. The method of claim 21, further comprising establishing communications between a tracking unit and the target.

23. The method of claim 21, further comprising storing and associating the point cloud with a specific probe type.

24. The method of claim 21, further comprising monitoring one or more encoders that output orientation information about the probe tip.

25. A method of measuring the position of an object comprising:
monitoring spherical coordinates of a laser emitting tracking unit;
monitoring a pitch, a yaw and a roll and of a target in communication with the tracking unit;
monitoring an orientation of a probe tip relative to the target;
determining a distance between the tracking unit and the target;
determining a distance between the probe tip and the target; and
outputting position information about the probe tip relative to the tracking unit.

26. The method of claim 25, wherein the roll is based on at least one of a comparison between a horizontally polarized and a vertically polarized portion of the laser, and en electronic level.

27. The method of claim 26, wherein a differential amplifier performs the comparison between the horizontally polarized and the vertically polarized portion of the laser.

28. The method of claim 25, wherein the target is an active target that is capable of moving relative to the laser.

29. The method of claim 28, wherein the active target is at least one of incorporated into a robotic device, fixably attached to an object, fixably attached to a vehicle, used for feedback control, used for calibration, used for machine tool control, used for parts assembly, and used for structural assembly.

30. The method of claim 25, further comprising performing a function at the target based at least on the position of the probe tip.

31. The method of claim 25, wherein determining a distance between the probe tip and the target is based on correlating at least the distance to a point cloud.

32. The method of claim 25, wherein monitoring an orientation of a probe tip relative to the target comprises monitoring position information obtained from one or more encoders.

33. The method of claim 25, wherein the one or more encoders measure at least one of rotation and extension information about the probe tip relative to the target.

34. A system that initializes a multidimensional measurement system comprising:
means for determining a probe type;
means for monitoring one or more of rotation of probe base and position of probe relative to a target defined by arc [symbol] ;
means for placing a probe tip in a known location;
means for moving the target relative to the known location; and
means for developing a point cloud representing a distance between the probe tip and a known location on the target.

35. The system of claim 34, further comprising means for establishing communications between a tracking unit and the target.

36. The system of claim 34, further comprising means for storing and associating the point cloud with a specific probe type.

37. The system of claim 34, further comprising means for monitoring one or more encoders that output orientation information about the probe tip.

38. A system that measures the position of an object comprising:
means for monitoring spherical coordinates of a laser emitting tracking unit;
means for monitoring a pitch, a yaw and a roll and of a target in communication with the tracking unit;
means for monitoring an orientation of a probe tip relative to the target;
means for determining a distance between the tracking unit and the target;
means for determining a distance between the probe tip and the target; and
means for outputting position information about the probe tip relative to the tracking unit.

39. The system of claim 38, wherein the roll is based on at least one of a comparison between a horizontally polarized and a vertically polarized portion of the laser, and en electronic level.

40. The system of claim 38, further comprising means for performing the comparison between the horizontally polarized and the vertically polarized portion of the laser.

41. The system of claim 38, wherein the target is an active target that is capable of moving relative to the laser.

42. The system of claim 41, wherein the active target is at least one of incorporated into a robotic device, fixably attached to an object, fixably attached to a vehicle, used for feedback control, used for calibration, used for machine tool control, used for parts assembly, and used for structural assembly.

43. The system of claim 38, further comprising means for performing a function at the target based at least on the position of the probe tip.

44. The system of claim 38, wherein the means for determining a distance between the probe tip and the target is based on a means for correlating at least the distance to a point cloud.

45. The system of claim 38, wherein the means for monitoring an orientation of a probe tip relative to the target comprises means for monitoring position information obtained from one or more encoders.

46. The system of claim 45, wherein the one or more encoders measure at least one of rotation and extension information about the probe tip relative to the target.

47. A probe assembly adapted to measure one or more points comprising:
a target that at least communicates position information about the target to a base station;
a probe comprising a probe tip that is associated with the target, the location of the probe capable of being determined based on a point cloud.

48. The probe of claim 47, further comprising

49. The probe of claim 47, where the probe assembly is capable of continuously taking surface measurements.

50. The probe of claim 47, further comprising a trigger activated measurement system.
